(19) United States
(12) Patent Application Publication
(10) Pub. No.: US 2008/0085630 A1
(43) Pub. Date: Apr. 10, 2008

(54) Coaxial Cable Connector

(76) Inventor: Jeremy Amidon, Marcellus, NY (US)

Correspondence Address: PASTEL LAW FIRM, 8 PERRY LANE, ITHACA, NY, 14850, US

(21) Appl. No.: 11/539,051

(22) Filed: Oct. 5, 2006

(51) Int. Cl. H01R 9/05

(52) U.S. Cl. 439/578

(57) ABSTRACT

A coaxial cable connector includes a combination of knurled portions and elastomeric rings on an outer body of the connector. Such a combination of knurled and elastomeric rings permits hand-tightening the cable connector onto an RF equipment port or other device.

### FIELD OF THE INVENTION

This invention relates generally to the field of coaxial cable connectors, and more particularly to a coaxial cable connector incorporating both knurled and elastomeric portions on an outer shell of the connector.

### BACKGROUND OF THE INVENTION

Many coaxial cable connectors are slender and smooth, requiring the use of a wrench to tighten them properly when installing them onto a port. Especially in situations where security is not a problem, i.e., unauthorized access to the cable connector and RF equipment port is not of concern, the necessity of using a wrench during installation creates extra work and inconvenience for an installer. An example of a cable connector which requires an ordinary wrench during installation is shown in U.S. Design Pat. No. D475,975 (Fox).

### SUMMARY OF THE INVENTION

Briefly stated, a coaxial cable connector includes a combination of knurled portions and elastomeric rings on an outer body of the connector. Such a combination of knurled and elastomeric rings permits hand-tightening the cable connector onto an RF equipment port or other device.

According to an embodiment of the invention, a coaxial cable connector includes an outer body; an inner body fitted inside the outer body; a mandrel fitted at least partially inside the inner body; at least one knurled portion on the outer body; and at least one elastomeric ring on the outer body.

According to an embodiment of the invention, a method for manufacturing a coaxial cable connector includes the steps of providing an outer body; providing an inner body fittable inside the outer body; providing a mandrel fittable at least partially inside the inner body; forming at least one knurled portion on the outer body; and fitting at least one elastomeric ring on the outer body.

### BRIEF DESCRIPTION OF THE DRAWINGS

FIG. 1 shows a perspective view of a cable connector with a combination of knurled portions and elastomeric rings according to an embodiment of the invention.

FIG. 2 shows an exploded view of the cable connector of FIG. 1 along with a coaxial cable which is to be connected to the cable connector.

FIG. 3 shows a cross-sectional view of the cable connector of FIG. 1 in a first stage of connecting the coaxial cable to the cable connector.

FIG. 4 shows a cross-sectional view of the cable connector of FIG. 1 in a second stage of connecting the coaxial cable to the cable connector.

FIG. 5 shows a cross-sectional view of the cable connector of FIG. 1 in a final stage of connecting the coaxial cable to the cable connector.

### DETAILED DESCRIPTION OF THE PREFERRED EMBODIMENT

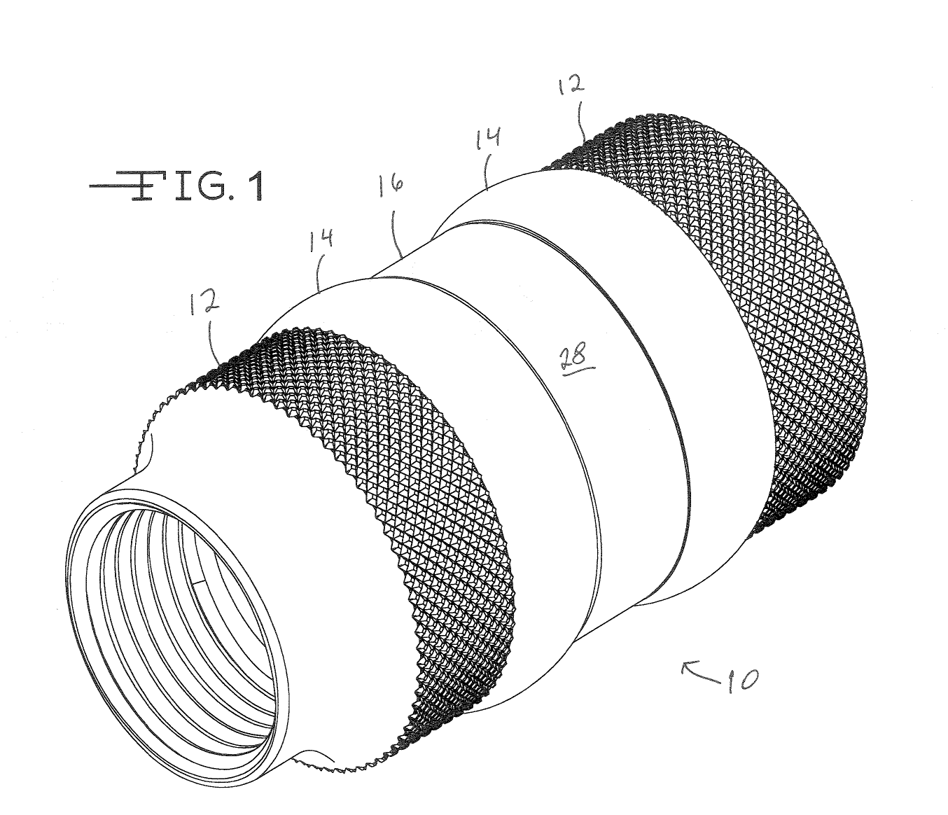

Referring to FIG. 1, a connector 10 is shown which includes an outer body 16 with knurled portions 12 and elastomeric rings 14 adjacent to knurled portions 12. Elastomeric rings 14 are preferably flattened so as not to add appreciably to an outer diameter of outer body 16. Outer body 16 is preferably of brass for its electrical and mechanical properties, but any conductive material with suitable mechanical properties could be used instead. In the embodiment shown, two knurled portions 12 are shown with two elastomeric rings 14 and a smooth portion 28 between them which permits marking, stamping, or bar coding on outer body 16. Knurled portions 12 are shown as preferably cross-hatched ridges that are generally angled 45 degrees with a major axis of outer body 16, known as diamond knurled. Such texturing provides an excellent surface for gripping with fingers and hand, either bare or gloved. When knurled portions 12 are optionally parallel ridges parallel to the major axis of outer body 16, they could be formed by extrusion when outer body 16 is formed, in which case smooth portion 28 is preferably machined smooth after outer body 16 is extruded. The texturing of knurled portions 12 could also be helix knurl.

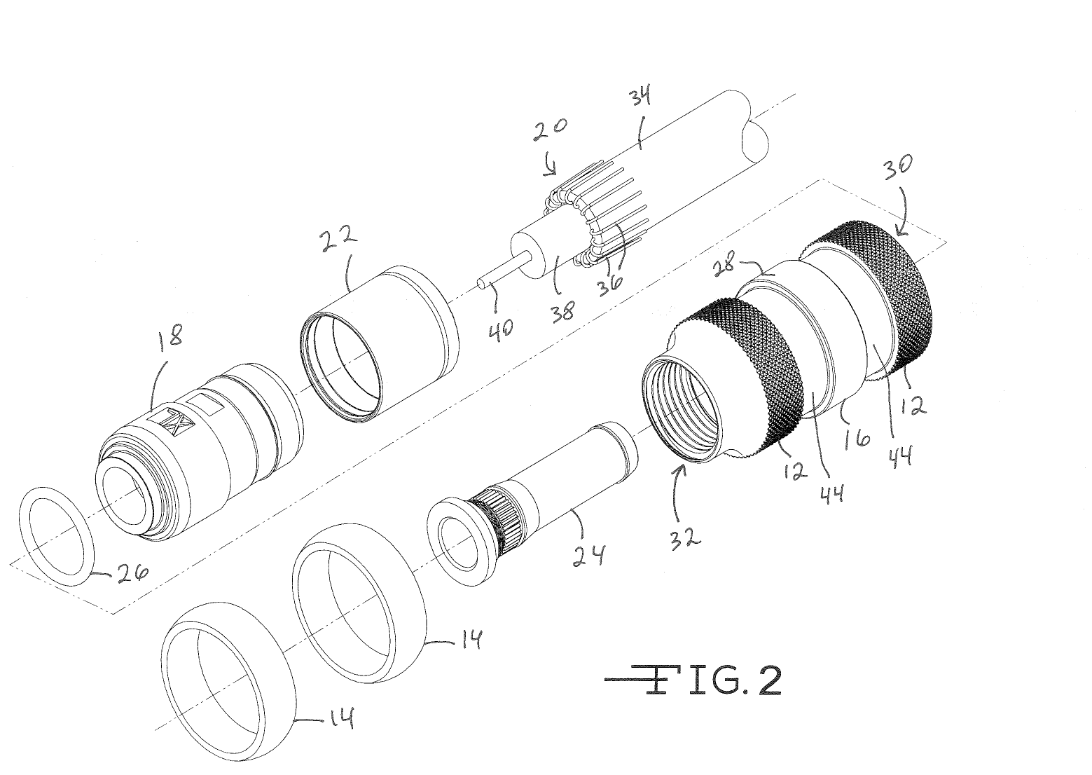

Referring to FIG. 2, other components of connector 10 are shown as well as a coaxial cable 20. Note that coaxial cable 20 has been properly prepared for connection with connector 10, i.e., an outer sleeve or sheath 34 is cut away, a metallic braid or shield 36 is bent back, a portion of a dielectric 38 is exposed, and a center conductor 40 extends from the dielectric. In this embodiment, connector 10 includes a mandrel 24, a compression sleeve 22, an inner body 18, and an O-ring 26. The use of knurled portions 12 in combination with elastomeric rings 14 is not unique to this embodiment, but may be used on any coaxial cable connector. Cable connector 10 is assembled as follows. O-ring 26 is emplaced on inner body 18, after which inner body 18 is inserted into outer body 16 from an end 30 of outer body 16. Mandrel 24 is then inserted into the inner body 18 and outer body 16 combination from an end 32. Elastomeric rings 14 may be added to outer body 16 at any point during the assembly, preferably fitting into annular grooves 44. Compression sleeve 22 is preferably pressed lightly into end 30 for completeness of the uncompressed connector unit, because sleeve 22 has to be removed from the remainder of connector 10 when installing connector 10 onto coaxial cable 20.

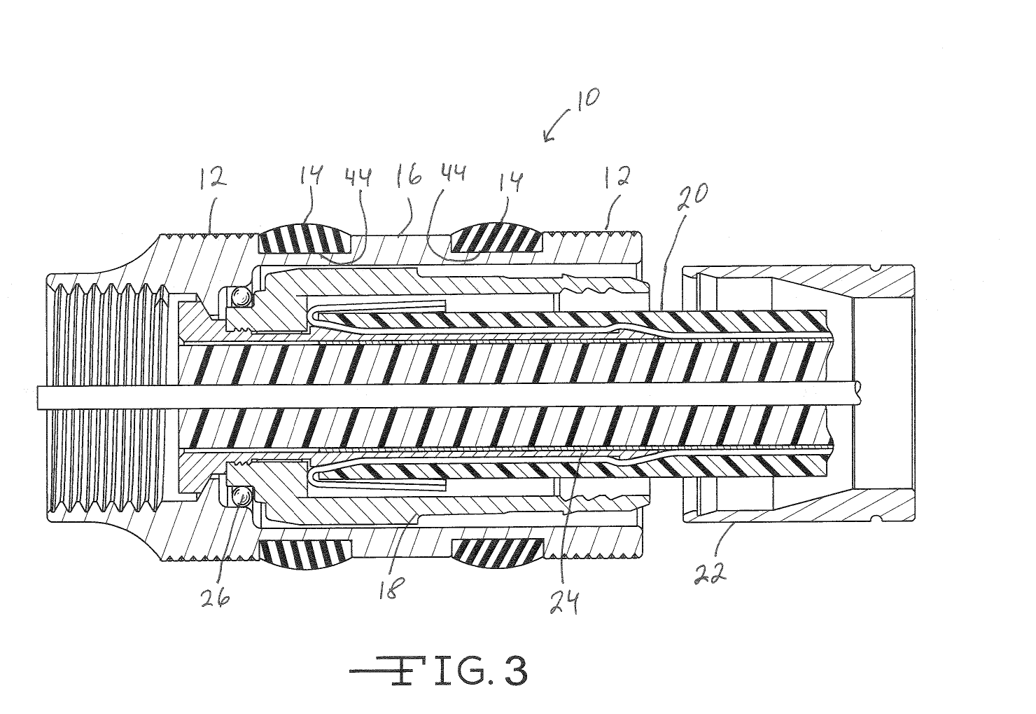

Referring to FIG. 3, a cross-section view of connector 10 and coaxial cable 20 is shown. Coaxial cable 20 is inserted through compression sleeve 22 and into the remainder of connector 10. Sleeve 22 is aligned with the remainder of connector 10 at this point. Mandrel 24 is inserted between sheath 34 and dielectric 38. Elastomeric rings 14 are preferably flat on a side adjacent annular grooves 44, but are preferably slightly rounded on another side to aid in gripping with the fingers and hand when an installer is installing or removing connector 10 from an equipment port (not shown) or other connection.

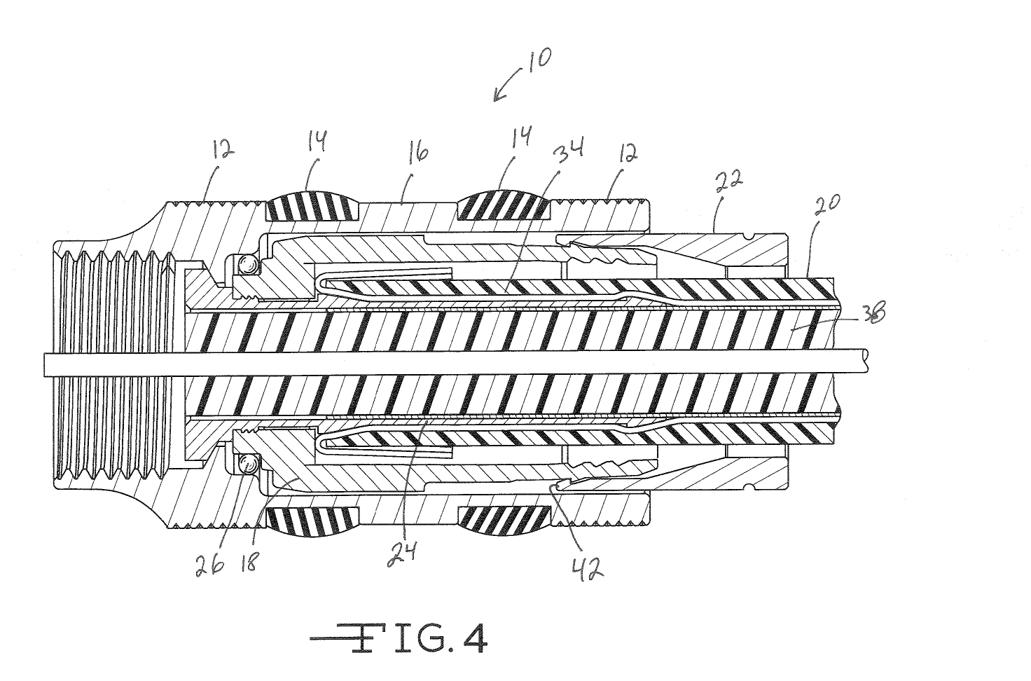

Referring to FIG. 4, sleeve 22 is pushed into connector 10, with an end 42 of sleeve 22 pressing between outer body 16 and inner body 18. Establishing the connection to this point is generally possible using hands only.

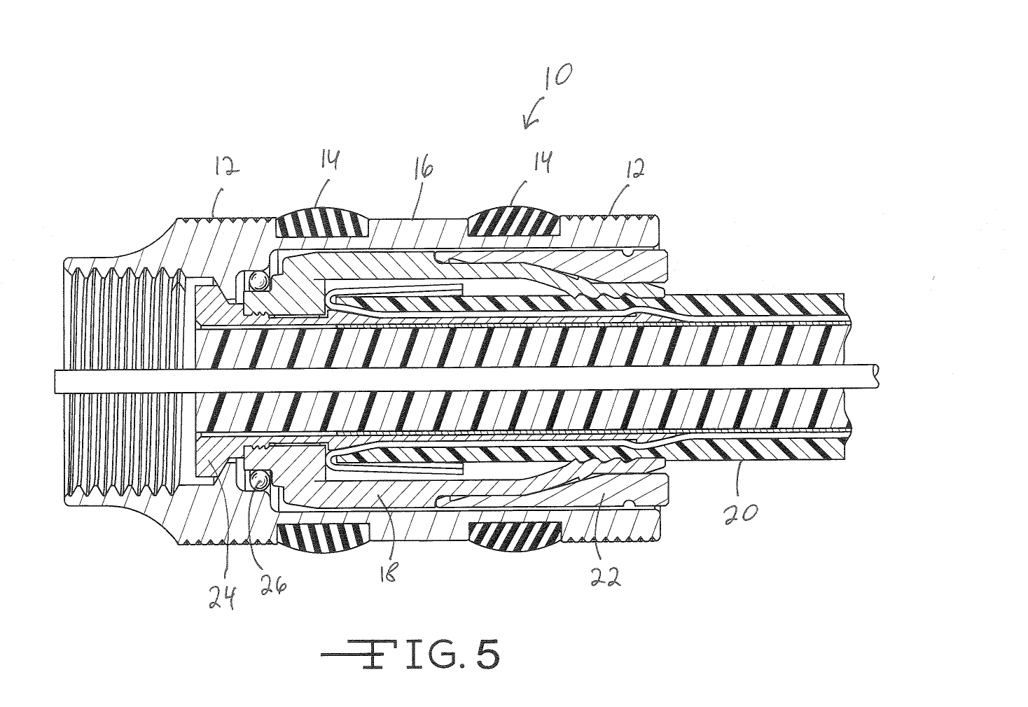

Referring to FIG. 5, sleeve 22 is pushed as far as possible into the remainder of connector 10 with the aid of a compression tool (not shown). A portion of inner body 18 is forced onto cable sheath 20 to grip and seal the connection from environmental influences. Connector 10, with coaxial cable 20 firmly attached, is now ready for connection to an RF equipment port. Such a connection can now be made with the hands only, i.e., no wrench is needed, owing to the combination of knurled portions 12 and elastomeric rings 14.

While the present invention has been described with reference to a particular preferred embodiment and the accompanying drawings, it will be understood by those skilled in the art that the invention is not limited to the preferred embodiment and that various modifications and the like could be made thereto without departing from the scope of the invention as defined in the following claims.

1. A coaxial cable connector, comprising:
an outer body;
an inner body fitted inside the outer body;
a mandrel fitted at least partially inside the inner body; and
at least one elastomeric ring on the outer body, wherein the at least one elastomeric ring is configured to aid in the installation or removal of the coaxial cable connector, when gripped by a hand or fingers of a user, to an equipment port.

2. A coaxial cable connector according to claim 13, wherein the at least one knurled portion includes first and second knurled portions, and wherein the at least one elastomeric ring includes first and second elastomeric rings.

3. A coaxial cable connector according to claim 2, wherein the first elastomeric ring is adjacent the first knurled portion and the second elastomeric ring is adjacent the second knurled portion.

4. A coaxial cable connector according to claim 3, further comprising a smooth portion on the outer body between the first and second elastomeric rings.

5. A coaxial cable connector according to claim 3, wherein the outer body includes first and second annular grooves, wherein the first and second elastomeric rings are constrained in the first and second annular grooves.

6. A coaxial cable connector according to claim 5, wherein the first and second elastomeric rings are flat on an inner side adjacent the outer body, and curved on an opposite outer side.

7. A method for manufacturing a coaxial cable connector, comprising the steps of:
providing an outer body;
providing an inner body fittable inside the outer body;
providing a mandrel fittable at least partially inside the inner body;
fitting at least one elastomeric ring on the outer body, wherein the at least one elastomeric ring is configured to aid in the installation or removal of the coaxial cable connector, when gripped by a hand or fingers of a user, to an equipment port.

8. A method according to claim 14, wherein the at least one knurled portion includes first and second knurled portions, and wherein the at least one elastomeric ring includes first and second elastomeric rings.

9. A method according to claim 8, further comprising the step of positioning the first elastomeric ring adjacent the first knurled portion and positioning the second elastomeric ring adjacent the second elastomeric ring.

10. A method according to claim 9, further comprising the step of forming a smooth portion on the outer body between the first and second elastomeric rings.

11. A method according to claim 9, further comprising the steps of forming first and second annular grooves in the outer body, and constraining the first and second elastomeric rings in the first and second annular grooves.

12. A method according to claim 11, further comprising the step of forming the first and second elastomeric rings with an inner flat side adjacent the outer body, and curved on an opposite outer side.

13. A coaxial cable connector according to claim 1, further comprising at least one knurled portion on the outer body.

14. A method according to claim 7, further comprising the step of forming at least one knurled portion on the outer body.
